(19) United States
(12) Patent Application Publication
(10) Pub. No.: US 2018/0085771 A1
(43) Pub. Date: Mar. 29, 2018

(54) Retractable Multi-function Irrigation Outcomer

(71) Applicant: Ruihuan Xie, Ningbo (CN)

(72) Inventor: Ruihuan Xie, Ningbo (CN)

(21) Appl. No.: 15/389,383

(22) Filed: Dec. 22, 2016

(30) Foreign Application Priority Data
Sep. 29, 2016 (CN) 201621106630.8

(51) Int. Cl. B05B 15/10; A01G 25/00; F16L 1/028; B05B 3/04

(52) U.S. Cl. CPC B05B 15/10; B05B 3/04; F16L 1/028; A01G 25/00

(57) ABSTRACT

A retractable multi-function irrigation outcomer includes fixed seat (4), shell (11), inner rod (10), earth drill (2), soil scraper (3), upper cover (6); upper cover (6) is connected to the outer wall of upper end of shell (11), and fixed seat (4) is fitted inside inner wall of upper end of shell (11); soil scraper (3) is flange type with flange plate installed between upper cover (6) and upper end face of fixed seat (4), and soil scraper (3) is closely fitted to outer wall of inner rod (10); inner rod (10) is cone-shaped in axial direction, and diameter of the end far from soil scraper (3) is larger than that of the other end close to soil scraper (3). With the structure, the condition where soil is accumulated around inner rod can be avoided, thus ensuring the normal stretch of inner rod and normal serviceable performance of irrigation outcomer.

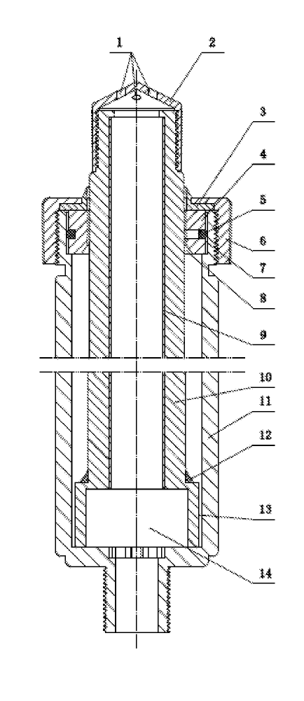

### CROSS REFERENCE TO RELATED APPLICATIONS

The present application claims the benefit of Chinese Utility Model Application No. 201621106630.8 filed on Sep. 29, 2016. All the above are hereby incorporated by reference.

### FIELD OF TECHNOLOGY

The application involves irrigation system technology, in particular, a kind of retractable multi-function irrigation outcomer.

### BACKGROUND

Outcomer which is commonly used in crops irrigation system is buried under the ground, and it is consist of shell, inner rod, earth drill and permanent seat, with the upper end of shell connected to permanent seat, the lower end connected to water supply pipes, inner rod in sliding connection inside shell, and the upper end of inner rod is connected to earth drill, and in sliding connection with permanent seat, in this way the flexible inner rod is connected inside shell, when the water flow through water supply pipes into the shell, it drives inner rod to move upward, simultaneously the water are transported from permanent seat into soil, drip irrigation for roots of crops is fulfilled. But, this traditional retractable multi-function irrigation outcomer has following disadvantages:

1) Because inner rod is generally cylinder-shaped, which means diameters of all parts are the same, thus, after long-term stretch out of ground and retract under the ground, the soil sink and cover the inner rod, and the inner rod with soil attached to it is not able to retract under the ground normally, so, it is inconvenience to use, and requires repairing frequently;

2) Connection between base of inner rod and inner wall of shell of traditional retractable multi-function irrigation outcomer is sealed with seal ring, in case impurities in water flow inside the outcomer, they are prone to accumulate around the seal ring, which leads to increased force of friction from seal ring, and then the inner rod is not able to move;

3) Even worse, the inner rod extending above the ground shall be connected to external irrigation equipment for use, it is probably to break when it moves or wobbles under the external force caused by external equipment, which means its service life cannot be ensured;

4) On the top of traditional retractable outcomer for spraying and dripping irrigation is the single-hole earth drill, and it is prone to be blocked, thus the water cannot be delivered, which leads to its failure to extend out of ground.

### SUMMARY

The application makes solutions to the technical problems of providing a retractable multi-function irrigation outcomer which can prevent dirt from heaping on the inner rod, so as to ensure its normal scalability and the normal usability of outcomer.

To solve above technical problems, the retractable multi-function irrigation outcomer provided by this application includes fixed seat (permanent seat), shell, internal team and earth drill, the upper end of shell connected with fixed seat, inner rod connected within shell, the upper end of inner rod connected with earth drill as well as fixed steam; the retractable multi-function irrigation outcomer also includes soil scraper and upper cover; the upper cover is connected with inner wall at the upper port of shell, and the fixed seat is in the inner wall at the upper port of shell; the soil scraper is connected between upper cover and the upper face of fixed seat, and also fitted tightly with inner wall of inner rod; the inner rod is cone-shaped body in axial direction, and the diameter size of one end away from earth drill is greater than the other end near it.

The close-fitting parts between soil scraper and the outer wall of inner rod include cylindrical section and conical section, the outer wall of cylindrical section fitted tightly with the centre hole of upper cover, conical section fitted tightly with outer wall of inner rod.

The upper cover is an inverted U-shape. The inner wall of U-shape side wall on upper cover is equipped with internal thread connected with external thread on the upper end of shell. The bottom of U-shape on the upper cover is equipped with centre hole fitted tightly with cylindrical section of soil scraper.

The upper end of shell is equipped with countersink, with fixed seat in it, and the outer wall of fixed seat is connected tightly with the inner wall of countersink of shell through shape O sealing ring.

The inner rod is hollow tube, and the axial hole of inner rod is tightly equipped with metal stiffener to strengthen the intensity of inner rod. The inner stiffener is also hollow tube.

The lower end of inner rod is equipped with shaft shoulder, and the inside of inner rod at shaft shoulder is equipped with water storage chamber, with water storage chamber connected with axial hole of metal stiffener; and there is gap between outer wall of shaft shoulder and inner wall of shell.

The step at shaft shoulder of inner rod is equipped with triangular water seal ring with triangular section, its centre hole wall connected tightly with outer wall of inner rod, and its bottom connected tightly with the step surface of shaft shoulder. It forms a valve between the outer conical surface of triangular water seal ring and the lower end of fixed seat hole with the up and down slide of inner rod, and the corresponding lower end of fixed seat hole has a matching bell mouth with triangular water seal ring.

The top of earth drill is equipped with several drainage holes, and they are distributed along the circumferential direction.

After adopting the above structures, compared with existing technology, the application has the following advantages:

1) For inner rod is cone-shaped body in axial direction, diameter on upper end connected with outcomer is small, and diameter on lower end is large, so the retraction between inner rod and fixed seat is more convenient, avoiding the stuck phenomenon caused by incapable retraction; what's more, the outcomer is equipped with soil scraper, and the soil scraper will scrape the soil off outer wall of inner rod every time it retracts back, to protect the normal scalability of inner rod and to further protect the normal usability of outcomer;

2) For seal ring is removed at the bottom of inner rod and inner wall of shell, it avoids water impurities heaping up and affecting the scalability of rod. At the same time, the sealing function is replaced by triangular water seal ring. When the inner rod stretches into the top, triangular water seal ring tightly connected with fixed seat to achieve sealing effect;

3) The metal stiffener made of metal materials is installed in inner rod, which greatly increases the intensity of inner rod, and effectively prevents fractured situation of inner rod;

4) Earth drill is multi-hole earth drill, which can soften the top soil by more smoothly using water flow, and can be more convenient for inner rod to stretch out of ground.

### BRIEF DESCRIPTION OF THE DRAWING

The FIGURE is the structural representation of retractable multi-function irrigation outcomer about this application.

Where: 1. drainage hole (water outlet); 2. earth drill; 3. soil scraper; 4. fixed seat (permanent seat); 5. O-shape seal ring; 6. upper cover; 7. countersink; 8. bell mouth; 9. metal stiffener; 10. inner rod; 11. shell; 12. triangular water seal ring; 13. shaft shoulder; 14. water storage chamber.

### DETAILED DESCRIPTION

The following will make further details to this application through combining drawing and specific implementation patterns.

As it shown in the FIGURE of the structural representation of retractable multi-function irrigation outcomer about this application, it includes fixed seat 4, shell 11, inner rod 10 and earth drill 2. The top of shell 11 is connected with fixed seat 4, inner rod 10 is in sliding connection with shell 11, and the top of inner rod 10 is connected with earth drill 2 and is also in sliding connection with fixed seat 4. The retractable multi-function irrigation outcomer also includes soil scraper 3 and upper cover 6. The upper cover 6 is connected with outer wall at the upper port of shell 11, and fixed seat 4 is in the inner wall at the upper port of shell 11. The soil scraper 3 is connected between upper cover 6 and the upper face of fixed seat 4, and also fitted tightly with inner wall of inner rod 10. The inner rod 10 is cone-shaped body in axial direction, and the diameter size of one end away from earth drill 2 is greater than the other end near it 2.

The close-fitting parts between soil scraper 3 and the outer wall of inner rod 10 include cylindrical section and conical section, the outer wall of cylindrical section fitted tightly with the centre hole of upper cover 6, conical section fitted tightly with outer wall of inner rod 10.

The upper cover 6 is an inverted U-shape. The inner wall of U-shape side wall on upper cover 6 is equipped with internal thread connected with external thread on the upper end of shell 11. The bottom of U-shape on the upper cover 6 is equipped with centre hole fitted tightly with cylindrical section of soil scraper 3.

The upper end of shell 11 is equipped with countersink 7, with fixed seat 4 in it 7, and the outer wall of fixed seat 4 is connected tightly with the inner wall of countersink of shell 11 through O-shape sealing ring 5.

The inner rod 10 is hollow tube, and the axial hole of inner rod 10 is tightly equipped with metal stiffener 9 to strengthen the intensity of inner rod 10. The inner stiffener 9 is also hollow tube.

The lower end of inner rod 10 is equipped with shaft shoulder 13, and the inside of inner rod 10 at shaft shoulder 13 is equipped with water storage chamber 14, with water storage chamber 14 connected with axial hole of metal stiffener 9; and there is gap between outer wall of shaft shoulder 13 and inner wall of shell 11.

The step at shaft shoulder 13 of inner rod 10 is equipped with triangular water seal ring 12 with triangular section, its 12 centre hole wall connected tightly with outer wall of inner rod 10, and its 12 bottom connected tightly with the step surface of shaft shoulder 13. It forms a valve between the outer conical surface of triangular water seal ring 12 and the lower end of fixed seat 4 hole with the up and down slide of inner rod 10, and the corresponding lower end of fixed seat 4 hole has a matching bell mouth 8 with triangular water seal ring 12.

The top of earth drill 2 is equipped with several drainage holes 1, and they 1 are distributed along the circumferential direction.

The operating principle of the retractable multi-function irrigation outcomer about this application is as follows: it is buried under the earth's surface of 35 cm-40 cm. The water is sprayed by earth drill to soften and remove the top soil after it enters into the bottom of outcomer through water pipe, and inner rod stretches out of ground driven by water flow. The triangular water seal ring rises to fixed seat to complete seal, and the lower part of inner rod is connected tightly with soil scraper to prevent water from leaking. The top part of inner rod can be connected with irrigation equipment to supply water and complete the irrigation. After irrigation, the inner rod can be pressed back to underground artificially. At this time, soil scraper can scrape the soil off conical inner rod, to avoid next stuck and incapable retraction phenomenon.

What is said above is just an optimal and feasible implementation example about this application, and it cannot limit the power scope of this application. For technical personnel familiar with the field, any other corresponding changes by applying technical proposal and technical ideas of this application shall be within the protection scope claimed by this application.

What is claimed is:

1. A retractable multi-function irrigation outcomer, comprising a fixed seat (4), a shell (11), an inner rod (10), an earth drill (2), wherein the shell (11) is connected to the fixed seat (4), the inner rod (10) is in sliding connection within the shell (11), the upper end of the inner rod (10) is connected to the earth drill (2) and at the same time is in sliding connection with the fixed seat (4); the outcomer further comprises a soil scraper (3) and an upper cover (6); the upper cover (6) is connected to an outer wall of an upper end of the shell (11), and the fixed seat (4) is fitted inside an inner wall of the upper end of the shell (11); the soil scraper (3) is installed between the upper cover (6) and an upper end face of the permanent seat (4), and it is also closely fitted to an outer wall of the inner rod (10); the inner rod (10) is cone-shaped in axial direction, and a diameter of an end far from the soil scraper (3) is larger than that of the other end close to the soil scraper (3).

2. The retractable multi-function irrigation outcomer of claim 1, wherein a close-fitting part of the soil scraper (3) to the outer wall of the inner rod (10) comprises a cylindrical section and a cone section, with an outer wall of the cylindrical section closely fitted to a center bore of the upper cover (6), and the cone section closely fitted to the outer wall of inner rod.

3. The retractable multi-function irrigation outcomer of claim 2, wherein the upper cover (6) is inverted U-shaped, an internal thread which is connected to a thread on an outer wall of an external thread of the shell (11) is fitted on an inner wall of a U-shaped side wall of the upper cover (6), and a U-shape base of the upper cover (6) is fitted with a center bore which is closely fitted to a cylindrical section of the soil scraper (3).

4. The retractable multi-function irrigation outcomer of claim 3, wherein the shell (11) is fitted with a counter bore (7) on the top of the upper end, the fixed seat (4) is fitted inside the counter bore, and the outer wall of fixed seat (4) is tightly connected to an inner wall of the counter bore of the shell (11) with O-shaped seal ring.

5. The retractable multi-function irrigation outcomer of claim 1, wherein the inner rod (10) is hollow tube, a metal stiffener (9) which is used for strengthening the strength of the inner rod (10) is closely fitted at axially an extending bore of the inner rod (10), and the metal stiffener (9) is also hollow tube type.

6. The retractable multi-function irrigation outcomer of claim 5, wherein a shaft shoulder (13) is equipped on a lower end of the inner rod (10), and a water storage chamber (14) is equipped inside the inner rod (10) at the shaft shoulder (13), which is connected to axially an extending bore of the metal stiffener (9); and, there is clearance between an outer wall of shaft shoulder (13) and the inner wall of shell (11).

7. The retractable multi-function irrigation outcomer of claim 6, wherein a triangular water seal ring (12) with triangular cross section is positioned on step of a shaft shoulder of the inner rod (10), and a center bore wall of the triangular water seal ring (12) is closely fitted to the outer wall of inner rod (10), a bottom face of the triangular water seal ring (12) closely fitted to the face of the step of the shaft shoulder (13), a conical surface of an outer side of the triangular water seal ring (12) and a lower end of a porthole of the fixed seat (4) form a valve with a slide of inner rod (10), correspondingly, a bellmouth (8) matching the triangular water seal ring (12) is equipped on the lower end of the porthole of the fixed seat (4).

8. The retractable multi-function irrigation outcomer of claim 1, wherein there are several water outlets (1) on the top of the earth drill (2), and the water outlets (1) are distributed evenly in peripheral direction.
